(19) United States
(12) Patent Application Publication
(10) Pub. No.: US 2023/0267157 A1
(43) Pub. Date: Aug. 24, 2023

(54) PROVIDING ONE SEARCH RESULT BASED ON SEARCH QUERY

(71) Applicant: Collin Longmire, Chicago, IL (US)

(72) Inventor: Collin Longmire, Chicago, IL (US)

(21) Appl. No.: 18/112,851

(22) Filed: Feb. 22, 2023

Related U.S. Application Data
(60) Provisional application No. 63/312,716, filed on Feb. 22, 2022.

(51) Int. Cl. G06F 16/9532; G06F 16/9538; G06F 16/9535

(52) U.S. Cl. CPC G06F 16/9532; G06F 16/9538; G06F 16/9535

(57) ABSTRACT

In an embodiment of the disclosed principles, a system and method are provided to output one search result for a user based a search query, thus allowing quick and automated decision making.

### TECHNICAL FIELD

The present disclosure relates generally to search engines, and more specifically to a system and method for providing one search result in response to a search query for quick and automated decision making.

### BACKGROUND

Search engines are well known in the art and are effective means to provide for searches of online information via the World Wide Web (WWW). A search engine typically receives a search query (e.g., one or more words) inputted by a user of the search engine. The search engine performs the search query and outputs results (also known as search results or hits) that are usually presented in a ranked list.

Search results are typically based on various algorithms that attempt to provide relevant search results based on a received search query. For example, if a user searches “best burger place near me” in a search engine, the search engine presents a list of restaurants that serve burgers with reviews, locations, opinion articles, and the like. This, however, can be troublesome and time consuming for the user to view each result in order to decide which restaurant to choose from. It would be advantageous to have a solution that presents one search result for the user based on a search query, thereby providing a quick and automated decision for the user.

Before proceeding, it should be appreciated that while the present disclosure is directed to a system that may address some of the shortcomings listed or implicit in this Background section, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to accurately catalog or comprehensively summarize any prior art reference or practice. As such, the inventors expressly disclaim this section as admitted or assumed prior art. Moreover, the identification herein of one or more desirable courses of action reflects the inventors' own observations and ideas, and should not be assumed to indicate an art-recognized desirability.

### SUMMARY

Therefore, it is an object of the present invention to provide a system and method that outputs one search result for the user from a search query for quick and automated decision making. In an embodiment of the disclosed principles, the system and method of use in accordance with the present application overcomes one or more of the above-discussed problems commonly associated with conventional search engines. Specifically, the system of the present invention provides one search result from a search query to the user quickly, thereby automating decision making for the user.

These and other unique features of the system and method of use are discussed below and illustrated in the accompanying drawings. The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

Other features and aspects of the disclosed principles will be apparent from the detailed description taken in conjunction with the included figures, of which:

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a schematic representation of an exemplary system for providing one search result, according to a preferred embodiment of the present invention; and

FIG. 2 is a block diagram illustrating an example computer system within which a set of instructions for causing a machine to perform any one or more of the methodologies discussed herein may be executed.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION

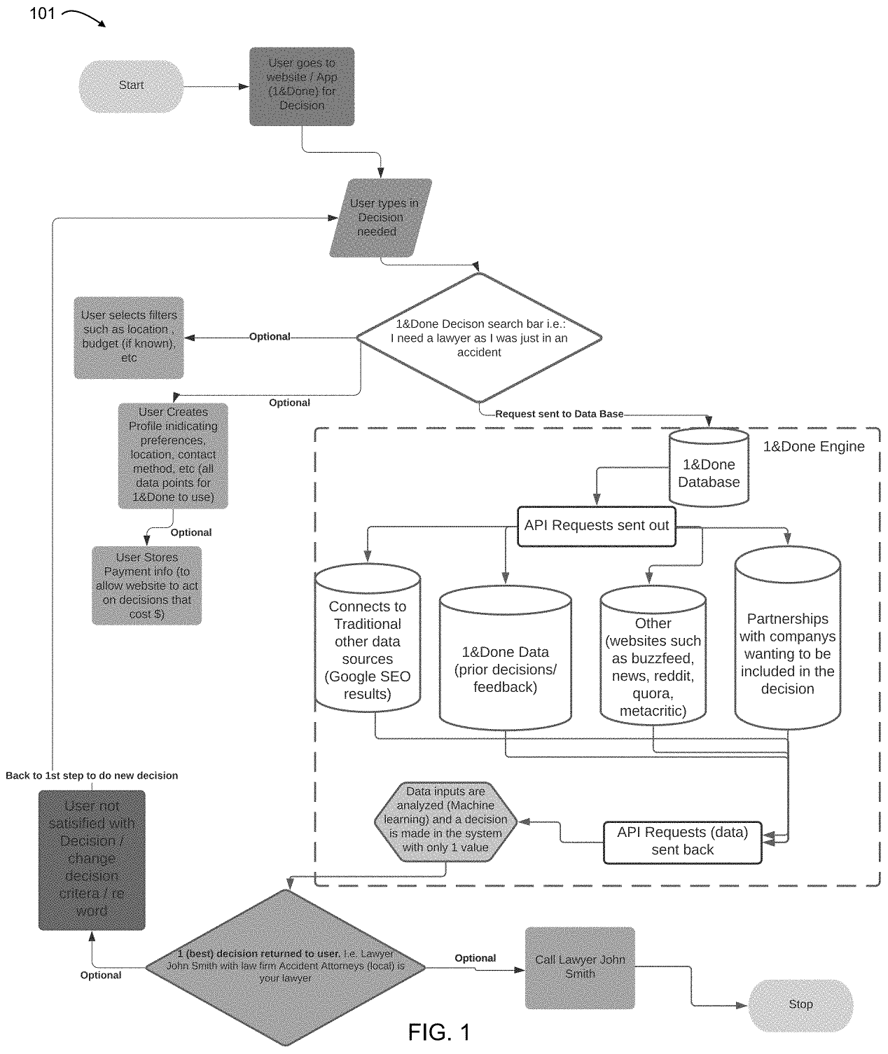

With this overview in mind, we turn now to a more detailed discussion of the disclosed principles in conjunction with the attached figures. Turning more specifically to the figures, FIG. 1 depicts a schematic representation of an exemplary system 101 for providing one search result in accordance with a preferred embodiment of the present application. It will be appreciated that system 101 overcomes one or more of the above-listed problems commonly associated with conventional search engines.

First, system 101 allows a user to access a website and/or application for a decision. As an option, the user can create a profile and store payment information and pre-selected filters (such as show results in zip code or by current location).

Next, the user enters a search query on the website and/or application for an automated decision. The search query is sent to a backend. Then, API requests are sent out to the internet.

Next, results from multiple databases are sent back via API's. Next, machine learning analyze and stack ranks uses proprietary solutions over results. As an option, system 101 may include partnership with businesses that will put said businesses higher ranked within decision making algorithm. Then, one result is presented to the user. It should be appreciated that the result is a decision automated for the user.

The user may then proceed with the presented result through one or more actions based on the content of the result. For example, if the result is for a food option, the user may place an order for the food option. In another example, if the result is for a movie selection to stream, the user may begin streaming the movie.

If the user is unsatisfied with the presented result, the user can enter a new search query. It should also be appreciated that one of the unique features believed characteristic of the present application is that it saves users' time by eliminating the need to review search results from a search query. In addition, the present invention enhances user convenience by automating a decision for the user which thus allows the user to move forward with tasks quickly.

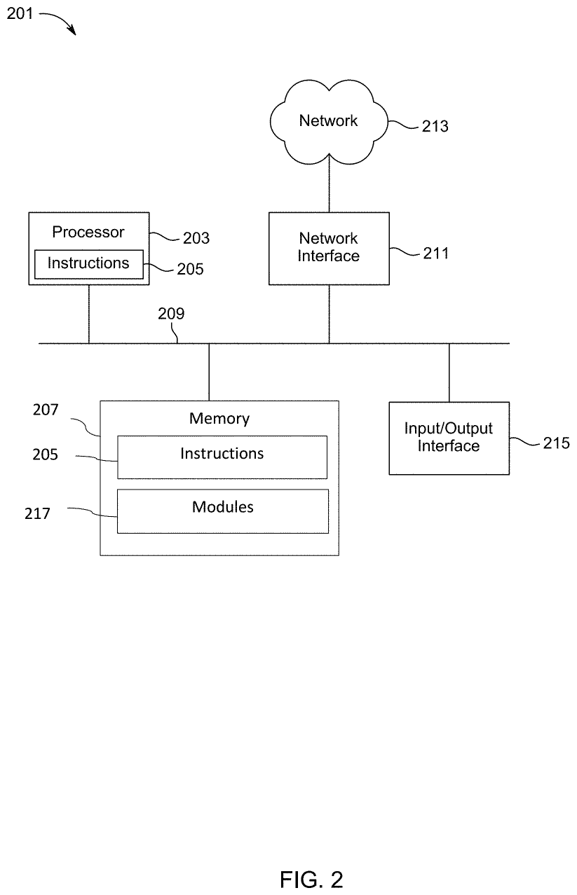

Referring now to FIG. 2, a block diagram of a computer system 201 within which a set of instructions may be executed for causing a machine to perform any one or more of the methodologies discussed herein, is depicted. The computer system 201 may correspond to any of the various computing devices, servers, mobile devices, embedded systems, or computing systems presented herein.

The computer system 201 may be implemented as any of a variety of conventional computing devices, including, for example, a desktop computer, a laptop, a tablet, a phablet, a workstation, an embedded controller, a server, a mobile device, a Specification Attorney Docket No. 9018CL-1PKM Page 5smartphone, an entertainment device, a printing machine (also referred as a printer or a printing device), a set-top box, a kiosk, a vehicular information system, one or more processors associated with a television, a customized machine, any other hardware platform, or any combination or multiplicity thereof. The computer system 201 may be a distributed system configured to function using multiple computing machines interconnected via a data network or bus system. Further, while only a single machine is illustrated, the term “machine” shall also be taken to include any collection of machines that individually or jointly execute a set (or multiple sets) of instructions to perform any one or more of the methodologies discussed herein.

The computer system 201 includes at least one processor 203 with or without one or more sets of instructions 205, a memory 207 with or without one or more sets of instructions 205, a network interface 209, and an input/output interface 211 which communicate with each other via a bus 213.

The processor 203 may be configured to execute code or instructions to perform the operations and functionality described herein, manage request flow and address mappings, and to perform calculations and generate commands. The processor 203 may be configured to monitor and control the operation of the components in the computer system 201. The processor 203 may be a general purpose processor, a processor core, a multiprocessor, a reconfigurable processor, a microcontroller, a digital processor (DSP), an application specific integrated circuit (ASIC), a graphics processing unit (GPU), a field programmable gate array (FPGA), a programmable logic device (PLD), a controller, a state machine, grated logic, discrete hardware components, any other processing unit, or any combination or multiplicity thereof. The processor 203 may be a single processing unit, multiple processing cores, special purpose processing cores, co-processors, or any combination thereof. In addition, the processor 203 along with other components of the computer system 201 may be a virtualized computing machine executing within one or more other computing machines.

The processor 203 may also be connected to the other elements of the computer system 201 or the various peripherals discussed herein through the bus 213. It should be appreciated that the bus 213 may be within the processor 203, outside the processor 203, or both. In some embodiments, any of the processor 203, the other elements of the computer system 201, or the various peripherals discussed herein may be integrated into a single device, for example, a system on a chip (SOC), system on package (SOP), or application-specific integrated circuit (ASIC) device.

The instructions 205 may reside, completely or at least partially, within the processor 203 and/or memory 207 during execution thereof by the computer system 201. The instructions 205 may include directions for storing instructions, performing one or more functions, and the like. For example, the instructions 205 may include detecting one or more files to perform one or more methodologies described herein. The instructions 205 may be configured to run in sequential order, in parallel (such as under different processing threads) or in a combination thereof. The instructions 205 may further be transmitted or received over a network 215 using a transmission medium, for instance network interface 209, and any one of a number of well-known transfer protocols (e.g., HTTP, HTTPS, FTP, TCP, and the like).

The network interface 207 facilitates communication with other computing systems (not shown) via one or more networks 215. Other computing systems, for example, may include conventional computing devices as described above, internet connected devices/systems, or an external storage such as a server, or a cloud computing system.

The computer system 201 may operate in a networked environment using logical connections through the network interface 209 to one or more other systems or computing machines across the network 215. The network 215 may include wide area networks (WAN), local area networks (LAN), the Internet, intranets, wireless access networks, wired networks, mobile networks, telephone networks, near field communication (NFC), optical networks, or combinations thereof. The network 215 may be packet switched, circuit switched, of any topology, and may use any communication protocol. Communication links within the network 215 may involve various digital or analog communication media, for example, fiber optic cables, free-space optics, waveguides, electrical conductors, wireless links, antennas, radio frequency communications, and the like.

The memory 207 may include volatile memories, for example, random access memory (RAM), static random access memory (SRAM), dynamic random access memory (DRAM), and synchronous dynamic random access memory (SDRAM). Other types of RAM also may be used to implement the memory 207. The memory 207 may also include non-volatile memories, for example, read-only memory (ROM), erasable programmable read-only (EROM), flash memories, or any other device capable of storing program instructions or data with or without applied power. In addition, the memory 207 may include a non-volatile storage device, for example, a hard disk, a floppy disk, an optical disk, a compact disk read only memory (CD-ROM), a digital versatile disc (DVD), a Blu-ray disc, a magnetic tape, a flash memory, other non-volatile memory device, a solid state drive (SSD), any magnetic storage device, any optical storage device, any semiconductor storage device, any physical-based storage device, any other data storage device, or any combination or multiplicity thereof.

The memory 207 may also include one or more modules 217 configured to facilitate the computer system 201 with performing the methodologies described herein. The module 217 may include one or more sets of instructions 205 stored as software or firmware in association with the memory 207. The memory 207 may therefore represent examples of machine or computer readable media on which instructions or code may be stored for execution by the processor 203. Machine or computer readable media may generally refer to any medium or media used to provide instructions to the processor 203. Such machine or computer readable media associated with the module 217 may comprise a computer software product. It should be appreciated that a computer software product comprising the module 217 may also be associated with one or more processes or methods for delivering the module 217 to the computer system 201 via the network 215, any signal-bearing medium, or any other communication or delivery technology. The module 217 may also comprise hardware circuits or information for configuring hardware circuits, for example, microcode or configuration information for a FPGA or other PLD.

The input/output (I/O) 211 may couple the computer system 201 to various input devices including keyboards, mice, touchscreens, touchpads, trackballs, joysticks, cameras, microphones, scanners, electronic digitizers, sensors, receivers, wireless remotes, and any other pointing devices, or any combination thereof. The I/O 211 may couple the computer system 201 to various output devices including video displays, speakers, printers, projectors, tactile feedback devices, automation control, robotic components, actuators, motors, fans, solenoids, valves, pumps, transmitters, signal emitters, lights, and the like.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “such that,” and “operable to” do not imply any particular tangible or intangible modification of a subject, but, rather, are intended to be used interchangeably. A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology.

A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The words “exemplary,” “exemplify,” and “example” are used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub combination or variation of a sub combination.

It will be appreciated that various systems and processes have been disclosed herein. However, in view of the many possible embodiments to which the principles of the present disclosure may be applied, it should be recognized that the embodiments described herein with are meant to be illustrative only and should not be taken as limiting the scope of the claims. Therefore, the techniques as described herein contemplate all such embodiments as may come within the scope of the following claims and equivalents thereof.

We claim:

1. A method for allowing a user to access a website and/or application for a decision, the method comprising:
receiving a user search query on the website or application for an automated decision;
sending the search query to a backend;
sending API requests out to the internet.
receiving results from multiple databases via the APIs;
analyzing the results via machine learning and stack ranks uses proprietary solutions over results provide an automated decision for the user.

2. The method in accordance with claim 1, further comprising receiving from the user a selection to proceed with the presented result.

3. The method in accordance with claim 1, further comprising receiving from the user a new search query.

4. The method in accordance with claim 1, further comprising receiving from the user data to create a profile, payment information and filter information.

5. The method in accordance with claim 4, wherein the filter information includes the user zip code or by current location.

6. The method in accordance with claim 1, wherein ranking the result comprises referring to stored information regarding a partnership with a business and ranking said business higher within a decision making algorithm.
